(19) United States
(12) Patent Application Publication
(10) Pub. No.: US 2024/0262653 A1
(43) Pub. Date: Aug. 8, 2024

(54) ABNORMAL NOISE DETECTION DEVICE, ELEVATOR DEVICE, METHOD, AND STORAGE MEDIUM

(71) Applicant: KABUSHIKI KAISHA TOSHIBA, Tokyo (JP)

(72) Inventors: Hiroyuki YANAGIHASHI, Kawasaki (JP); Takashi SUDO, Fuchu (JP); Kouta NAKATA, Tokyo (JP); Tsukasa IKE, Tokyo (JP)

(73) Assignee: KABUSHIKI KAISHA TOSHIBA, Tokyo (JP)

(21) Appl. No.: 18/454,241

(22) Filed: Aug. 23, 2023

(30) Foreign Application Priority Data
Feb. 7, 2023 (JP) 2023-017103

(51) Int. Cl. B66B 5/00; B66B 1/34; B66B 3/00; H04R 1/02; H04R 1/40; H04R 3/00

(52) U.S. Cl. CPC B66B 5/0018; B66B 1/3492; B66B 3/002; H04R 1/028; H04R 1/406; H04R 3/005

(57) ABSTRACT

According to one embodiment, an abnormal noise detection device includes a first processing circuit. The first processing circuit is configured to collect an operating noise of a moving body by a first microphone installed in the moving body; detect an abnormal noise in the operating noise; input position information of the moving body; and store history information in which a detection result of detecting the abnormal noise and the position information are associated with each other in a first memory. The first processing circuit is configured to determine presence or absence of abnormality of the moving body by integrating the detection result for each piece of the position information on a basis of the history information.

### CROSS-REFERENCE TO RELATED APPLICATION

This application is based upon and claims the benefit of priority from Japanese Patent Application No. 2023-17103, filed Feb. 7, 2023, the entire contents of which are incorporated herein by reference.

### FIELD

Embodiments described herein relate generally to an abnormal noise detection device, an elevator device, a method, and a storage medium.

### BACKGROUND

In industrial equipment and infrastructure facilities, periodic inspections are conducted to maintain safety. In many cases, industrial equipment and infrastructure facilities generate an abnormal noise at the time of abnormality. On the basis of this, there is an abnormal noise detection device that detects an abnormality by collecting operating noises of industrial equipment and infrastructure facilities with a microphone and analyzing a state of the operating noise. In this type of abnormal noise detection device, an abnormality is detected by using a microphone with respect to a moving body infrastructure facility such as an elevator device, thereby shortening a suspension time caused by the abnormality.

However, the abnormal noise detection device may erroneously detect an abnormal noise due to a disturbance from an ambient noise other than that of the moving body to be monitored. Such erroneous detection wastefully generates a suspension time of the moving body to be monitored, and thus it is desirable to reduce the erroneous detection.

### BRIEF DESCRIPTION OF DRAWINGS

FIG. 1 is a schematic diagram illustrating a configuration of an elevator device including an abnormal noise detection device according to a first embodiment.

FIG. 2 is a block diagram illustrating a configuration of the abnormal noise detection device according to the first embodiment.

FIG. 3 is a schematic diagram for explaining history information according to the first embodiment.

FIG. 4 is a schematic diagram for explaining integration information according to the first embodiment.

FIG. 5 is a flowchart for explaining an example of an operation in the first embodiment.

FIG. 6 is a diagram illustrating installation of a microphone according to a second embodiment.

FIG. 7 is a block diagram illustrating a configuration of the abnormal noise detection device according to the second embodiment.

FIG. 8 is a schematic diagram for explaining an ambient determination result according to the second embodiment.

FIG. 9 is a schematic diagram for explaining history information according to the second embodiment.

FIG. 10 is a diagram for explaining an example of integration determination based on the abnormality detection result and the ambient normality determination result according to the second embodiment.

FIG. 11 is a flowchart for explaining an example of an operation in the second embodiment.

FIG. 12 is a diagram illustrating installation of a microphone according to a third embodiment.

FIG. 13 is a block diagram illustrating a configuration of the abnormal noise detection device according to the third embodiment.

FIG. 14 is a block diagram illustrating a configuration of the abnormal noise detection device according to a fourth embodiment.

FIG. 15 is a diagram illustrating an example of a display screen according to the fourth embodiment.

FIG. 16 is a flowchart for explaining an example of an operation in the fourth embodiment.

FIG. 17 is a scatter diagram for estimating an abnormal site according to a fifth embodiment.

FIG. 18 is a diagram illustrating a hardware configuration of the abnormal noise detection device according to a sixth embodiment.

### DETAILED DESCRIPTION

In general, according to one embodiment, an abnormal noise detection device includes a first processing circuit. The first processing circuit is configured to collect an operating noise of a moving body by a first microphone installed in the moving body. The first processing circuit is configured to detect an abnormal noise in the operating noise. The first processing circuit is configured to input position information of the moving body. The first processing circuit is configured to store history information in which a detection result of detecting the abnormal noise and the position information are associated with each other in a first memory. The first processing circuit is configured to determine presence or absence of abnormality of the moving body by integrating the detection result for each piece of the position information on a basis of the history information.

Hereinafter, each embodiment will be described with reference to the drawings. In the following description, an elevator will be described as an example of the moving body, but the moving body is not limited thereto. As the moving body, for example, a moving device that passes through the same position a plurality of times, such as a train, a bus, and an automatic guided vehicle, are applicable. The plurality of travel paths may be the same as or different from each other. As used herein, “to pass through” includes a case where temporary stop is performed. In addition, when there is a return point in the travel path, “to pass through” includes “return travel” at the return point.

### First Embodiment

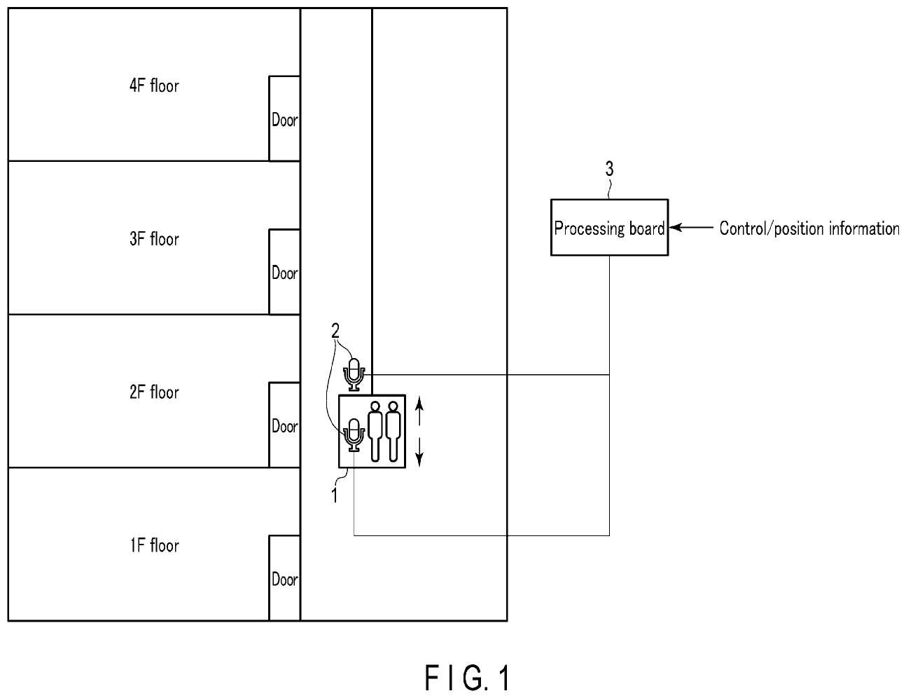

FIG. 1 is a schematic diagram illustrating a configuration of an elevator device including an abnormal noise detection device according to a first embodiment. The elevator device includes a car 1 that is a moving body, a moving body microphone 2 installed in the car 1, a processing board 3, and a normal elevator configuration (not illustrated) other than the car 1.

The car 1 has a space where a person gets on and off, and moves up and down by driving of a hoisting machine (not illustrated) or the like according to an operation by a person in front of a door of each floor or an operation by a person riding through the door. In FIG. 1, each floor is one of the first to fourth floors, but the present invention is not limited thereto. For example, the uppermost floor is not limited to the fourth floor. Similarly, the lowermost floor is not limited to the first floor, and may be any basement floor, for example.

The moving body microphone 2 is installed in the car 1 and collects the operating noise of the car 1. In this example, two moving body microphones are installed on the car 1 and in the car 1 respectively. As the moving body microphone 2 in the car 1, an intercom microphone may be used. The moving body microphone 2 is an example of a first sound collection unit.

The processing board 3 notifies the abnormality of the moving body by detecting an abnormal noise from the microphone signal sent from the moving body microphone 2. As the processing board 3, an edge board to be installed in the car 1, an edge board to be installed fixedly on the elevator uppermost floor or the like, an external board installed in a server capable of communicating with the elevator device, and the like can be appropriately used.

Here, the abnormal noise is detected at the time of car driving in which the car 1 moves up and down or at the time of door opening and closing in which the car 1 stops on a floor and opens and closes the door. Examples of the abnormal noise during car driving include an abnormal noise due to distortion of a guide rail of a hoistway, and an abnormal noise generated due to an abnormality of a balance weight, a hoisting machine, a speed governor, a brake, and the like. Examples of the abnormal noise at the time of opening and closing the door include an abnormal noise caused by a foreign matter being caught in an outer door or an inner door, an abnormal noise caused by a screw being loosened and coming into contact with the door, and an abnormal noise caused by a door being rubbed by a tightening of the door packing.

Note that the present invention is not limited thereto, and the abnormal noise may include a disturbance generated around the car 1. Examples of the disturbance include a sound caused by a voice or vibration emitted by a person in the car, a sound caused by a voice of a person or cleaning on each floor, a replacement operation of a vending machine, a construction of a building, and the like.

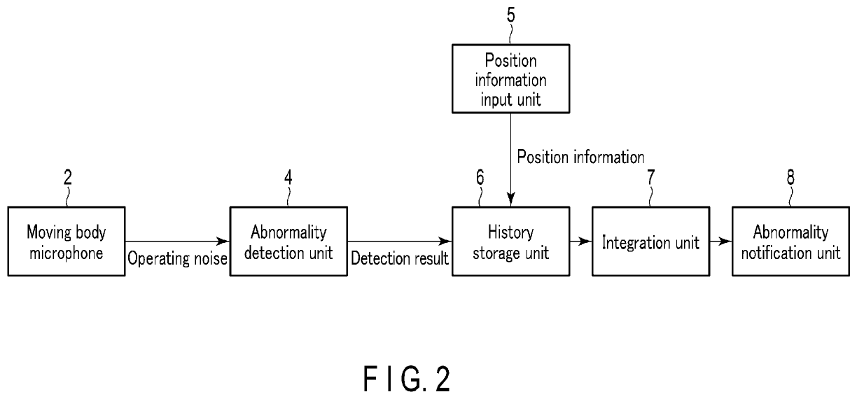

FIG. 2 is a block diagram illustrating an example of a configuration of the abnormal noise detection device according to the first embodiment. This abnormal noise detection device can be realized using, for example, a PC, a server computer, an edge device, or the like. The abnormal noise detection device includes a moving body microphone 2, an abnormality detection unit 4, a position information input unit 5, a history storage unit 6, an integration unit 7, and an abnormality notification unit 8.

Here, the moving body microphone 2 is as described above.

The abnormality detection unit 4 detects an abnormal noise from a microphone signal transmitted from the moving body microphone 2. For example, the abnormality detection unit 4 detects an abnormal noise in the operating noise of the car 1 collected by the moving body microphone 2. Here, the abnormality detection unit 4 may detect the abnormal noise by determining whether the collected operating noise is normal or abnormal. As an abnormality detection method of the abnormality detection unit 4, for example, there is a method of detecting on the basis of whether the volume of the operating noise is greater than or equal to a threshold. In addition, for example, as the abnormality detection method, a rule-based method of calculating and detecting the similarity between the feature amount in the time frequency domain obtained by converting the time signal of the operating noise by short-time Fourier transform or the like and the feature amount retaining types of the abnormal noise as a dictionary in advance can be used. Note that, as the similarity, for example, a sum of absolute difference values, cosine similarity, and the like can be used as appropriate. As other abnormality detection methods, in machine learning, methods such as a supervised abnormality detection method of learning normal data and abnormal data and an unsupervised abnormality detection method of learning only normal data and determining an abnormality different from normality can be used. Examples of the supervised abnormality detection method include a logistic regression, a support vector machine (SVM), a decision tree, and a method using a neural network. Examples of the unsupervised abnormality detection method include a method using a neural network such as an auto encoder, a clustering method, and the like.

The position information input unit 5 inputs the position information of the car 1 to the history storage unit 6. Note that the position information input unit 5 may constantly input the position information of the car 1, or may input the position information when the abnormality detection unit 4 detects an abnormal noise. In the case of an elevator, the position information may include information regarding floors such as a 1F floor and a 2F floor, and information regarding a middle of two floors such as between 1F and 2F. Alternatively, the position information may include information about a distance such as one meter above 1F. In addition to the position information, the position information input unit 5 may input elevator control information (for example, a destination floor and door open/close) according to the operation in the car 1.

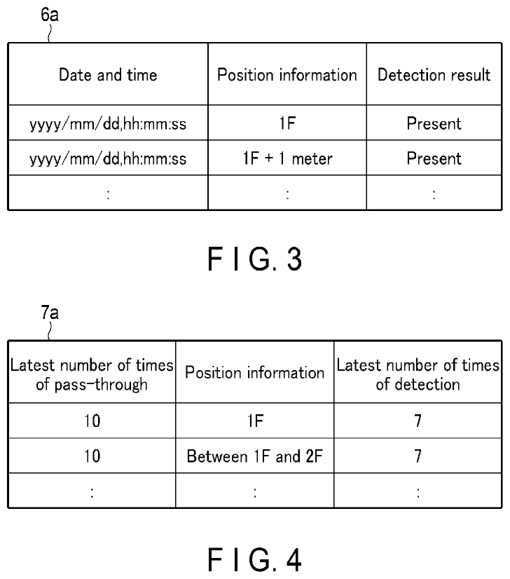

As illustrated in FIG. 3, the history storage unit 6 stores history information in which a detection result of detecting an abnormal noise is associated with position information. In the history information, date and time may be associated with the detection result and the position information. Further, the history information may include a detection result when the operating noise is normal.

The integration unit 7 determines the presence or absence of abnormality of the moving body by integrating the detection results for each piece of the position information on the basis of the history information. For example, the integrated result can be obtained by associating the latest number of times of detection (the number of abnormal noise detection results) for each piece of the position information. As illustrated in FIG. 4, the integrated result 7a may further associate the latest number of times of pass-through (sum of number of detection results of normal noise and number of detection results of abnormal noise) with the position information and the latest number of times of detection. In any case, the integration unit 7 determines the presence of the abnormality of the moving body when more than a certain number of the detection results are obtained at substantially the same position on the basis of the integrated result.

In a case where there is an abnormality of the moving body as a result of the determination by the integration unit 7, the abnormality notification unit 8 notifies the remote monitoring device (not illustrated) of the presence of the abnormality of the moving body.

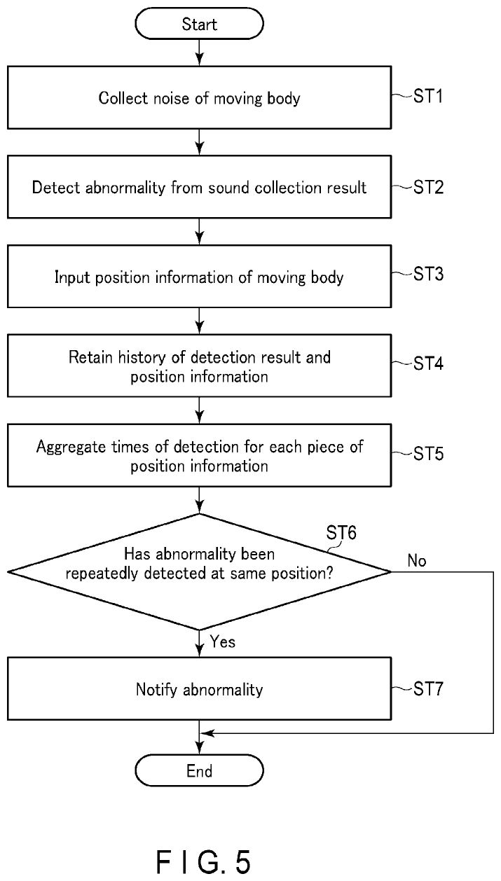

Next, the operation of the abnormal noise detection device configured as described above will be described with reference to the flowchart of FIG. 5.

In step ST1, the moving body microphone 2 that collects the sound of the moving body collects the operating noise of the car 1 and transmits a microphone signal which is a time-series sound signal.

In step ST2, the abnormality detection unit 4 detects an abnormality from the sound collection result on the basis of the transmitted microphone signal. Specifically, the abnormality detection unit 4 detects an abnormal noise in the collected operating noise.

In step ST3, the position information input unit 5 inputs the position information of the car 1 which is the moving body.

In step ST4, the history storage unit 6 stores the history information 6a in which the detection result of detecting the abnormal noise is associated with the position information.

In step ST5, the integration unit 7 integrates the detection results for each piece of the position information on the basis of the history information 6a. As the integrated result, the integration unit 7 aggregates the latest number of times of detection for each piece of the position information, and associates the obtained latest number of times of detection with the position information.

In step ST6, the integration unit 7 determines whether or not an abnormality has been repeatedly detected at the same position on the basis of the integrated result. Specifically, the integration unit 7 determines whether more than a certain number of detection results have been obtained at substantially the same position. As a result of this determination, when a certain number of detection results have been obtained at substantially the same position (ST6: Yes), it is determined that there is an abnormality of the car 1 as the moving body, and the process proceeds to step ST7. In addition, when a result of the determination in step ST6 is No, step ST7 is skipped and the process ends.

In step ST7, as a result of the determination by the integration unit 7, in a case where there is the abnormality of the car 1, the abnormality notification unit 8 notifies a remote monitoring device (not illustrated) of the presence of the abnormality of the moving body.

As described above, according to the first embodiment, the moving body microphone 2 is installed in the car 1 and collects the operating noise of the car 1. The abnormality detection unit 4 detects an abnormal noise in the operating noise. The position information input unit inputs position information of the moving body. The history storage unit stores history information in which a detection result of detecting an abnormal noise is associated with position information. The integration unit 7 determines the presence or absence of abnormality of the moving body by integrating the detection results for each piece of the position information on the basis of the history information. Therefore, it is possible to reduce erroneous detection of an abnormal noise due to ambient noises other than that of the moving body. As a supplement, the position information of the car 1 when the abnormal noise is detected in the operating noise of the car 1 is acquired and stored as the history information. Here, the disturbance varies from time to time, and is less likely to continuously occur at the same position. Considering such erroneous detection due to disturbance, it can be determined from the history information that, for example, when an abnormal noise is repeatedly detected at the same position, it is a true abnormality, and when an abnormal noise is detected singly, it is an erroneous detection due to the disturbance.

Further, according to the first embodiment, the integration unit 7 determines the presence of abnormality of the moving body when more than a certain number of detection results are obtained at substantially the same position on the basis of the integrated result. Therefore, in addition to the effects described above, it is possible to determine the presence of abnormality of the moving body according to a certain number of values as the threshold. For example, the threshold of the latest number of times of detection may be a constant number, or the threshold of the latest number of times of detection in the latest number of times of pass-through may be a constant number. Alternatively, the threshold of the number of times of detection in a predetermined period may be set to a constant number. In any case, in addition to the effects described above, it is possible to determine the presence of abnormality of the moving body according to a certain number of thresholds at the time of determination.

### Second Embodiment

In the first embodiment, the detection result of the abnormal noise is integrated for each piece of the position information of the moving body to determine the presence or absence of the abnormality of the moving body.

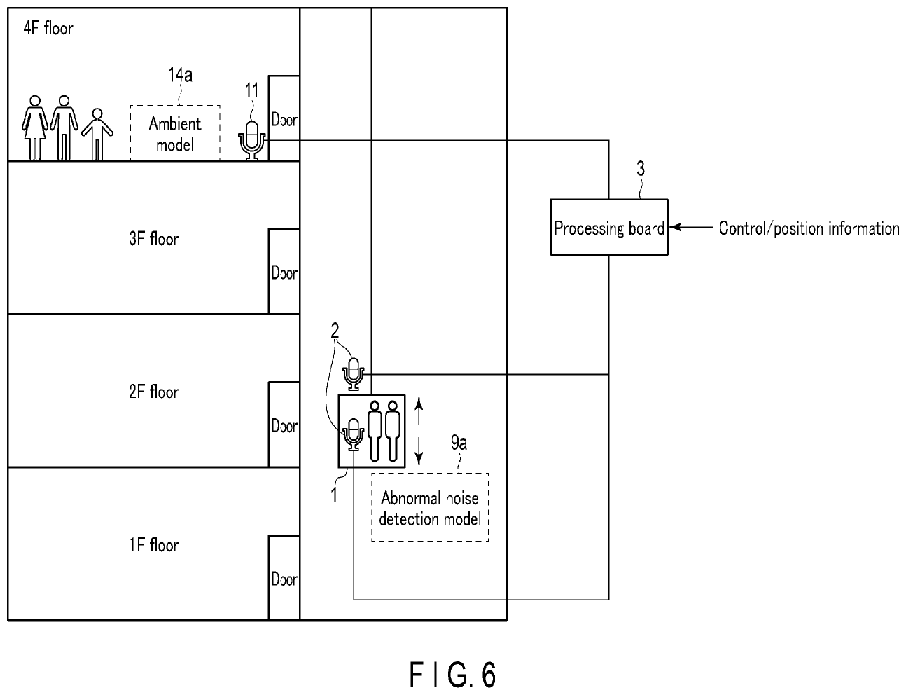

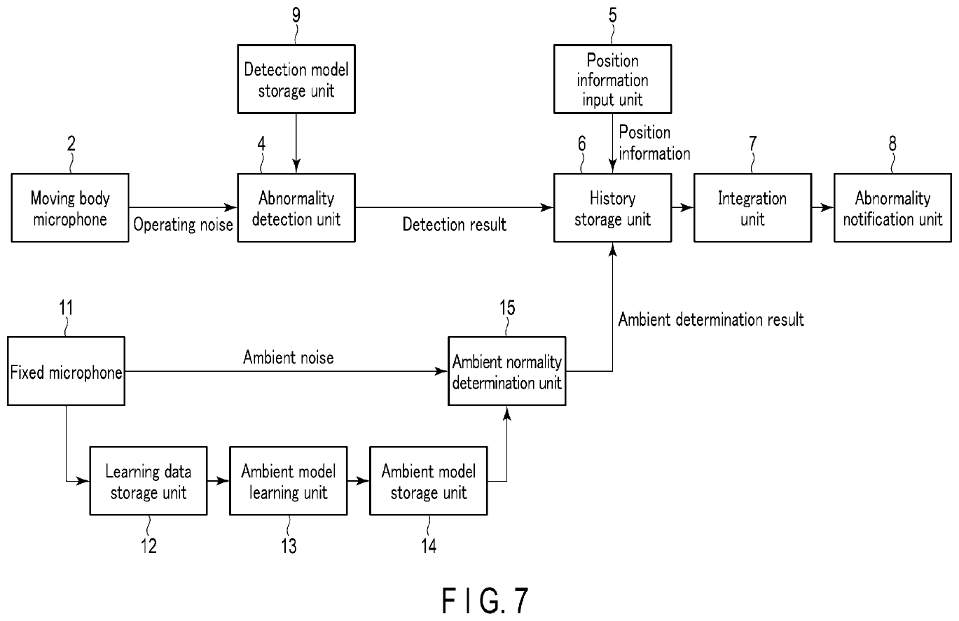

On the other hand, in the second embodiment, as illustrated in FIGS. 6 and 7, the presence or absence of abnormality of the moving body is determined by further using the ambient noise of the moving body. In FIGS. 6 and 7, configurations corresponding to those in FIGS. 1 and 2 are denoted by the same reference numerals and detailed description thereof is omitted. Only different configurations will be described hereafter. In the following embodiments and modifications as well, redundant description will be omitted.

As illustrated in FIG. 6, in the abnormal noise detection device of the second embodiment, as compared with FIG. 1, a fixed microphone 11 that collects ambient noise, an ambient model 14a that generates an abnormality degree of the ambient noise, and an abnormal noise detection model 9a that generates an abnormality degree of the operating noise are added. Note that the ambient model 14a and the abnormal noise detection model 9a are mounted on the processing board 3.

The fixed microphone 11 is provided at a position in the vicinity of the door of the 4F floor which is the uppermost floor among the 1F to 4F floors in the peripheral area along the hoistway which is the travel path of the car 1, and collects ambient noise at the provided position. As the position in the vicinity of the door, for example, a position on the floor side of the door such as a position of a call button on the floor, and a position on the hoistway side inside the door can be appropriately employed. The fixed microphone 11 is preferably installed on the floor side from the viewpoint of collecting the ambient noise on the travel path of the car 1. Note that, in a case where one fixed microphone 11 is provided, the fixed microphone may be provided not only at a position in the vicinity of the door of the uppermost floor but also at a position in the vicinity of the door of any one of the 1F to 3F floors. The fixed microphone 11 is an example of a second sound collection unit that is provided at at least one position in a peripheral area along the travel path of the moving body and collects ambient noise at the provided position.

Unlike the moving body microphone 2, the fixed microphone 11 can collect ambient noises of the fixed microphone 11 at all times. Therefore, it is possible to collect the ambient disturbance that varies day by day on a long-term basis and train the ambient model 14a. Therefore, it can be determined whether or not the ambient noise is a normal disturbance, by causing the ambient model 14a to machine-learn the daily ambient disturbance collected by the fixed microphone 11 and comparing the abnormality degree generated by the trained ambient model 14a with the threshold value. As a result, for example, in a case where the abnormality detection unit 4 erroneously detects an abnormal noise due to ambient disturbance, when it is determined that the ambient noise is normal, it can be determined that erroneous detection due to normal disturbance has occurred. By adding processing of determining the ambient situation, it is possible to further reduce erroneous detection and expect improvement in accuracy of abnormality detection.

FIG. 7 is a block diagram illustrating an example of a configuration of the abnormal noise detection device according to the second embodiment. In addition to the configuration illustrated in FIG. 2, the abnormal noise detection device includes a detection model storage unit 9, a fixed microphone 11, a learning data storage unit 12, an ambient model learning unit 13, an ambient model storage unit 14, and an ambient normality determination unit 15.

Here, the detection model storage unit 9 stores an abnormal noise detection model 9a which is a trained model for generating an abnormality degree of the operating noise based on the operating noise of the car 1 collected by the moving body microphone 2. Accordingly, the abnormality detection unit 4 uses the abnormal noise detection model 9a stored in the detection model storage unit 9 to input the operating noise to the abnormal noise detection model 9a, and determines whether an abnormal noise has been detected in the operating noise on the basis of the abnormality degree obtained from the abnormal noise detection model 9a and the threshold. In a case where an abnormal noise is detected (there is a detection result of the abnormal noise), the operating noise indicates an abnormal state, and in a case where no abnormal noise is detected (there is no detection result of the abnormal noise), the operating noise indicates a normal state. In addition, the abnormality detection unit 4 transmits information including date and time information, position information, an abnormality degree of the moving body, and presence or absence of a detection result to the history storage unit 6. The history storage unit 6 stores the transmitted information as history information. The detection model storage unit 9, the abnormal noise detection model 9a, and the abnormality detection unit 4 of the second embodiment may be applied to the first embodiment.

The fixed microphone 11 is provided at a position in the vicinity of the door of the 4F floor, and collects ambient noise of the provided position. In addition, the fixed microphone 11 collects the ambient noise and transmits a microphone signal which is a time-series audio signal to the learning data storage unit 12 and the ambient normality determination unit 15.

The learning data storage unit 12 stores learning data in which the ambient noise collected by the fixed microphone 11 is used as input data and the degree of abnormality degree corresponding to the degree of collected ambient noise different from daily disturbance is used as output data.

The ambient model learning unit 13 performs machine learning of the ambient model 14a using the learning data so as to create the trained model that generates an abnormality degree on the basis of the ambient noise. After completion of the machine learning, the ambient model learning unit 13 transmits the ambient model 14a, which is a trained model, to the ambient model storage unit 14.

The ambient model storage unit 14 is provided for each fixed microphone 11, and stores the ambient model 14a which is a trained model for generating the abnormality degree of the ambient noise on the basis of the collected ambient noise.

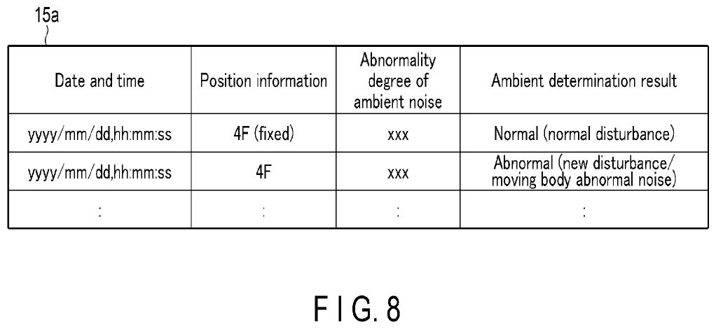

The ambient normality determination unit 15 is provided for each fixed microphone 11, and determines whether the ambient noise indicates normality or abnormality. For example, the ambient normality determination unit 15 inputs the ambient noise to the ambient model 14a which is a trained model, and determines whether or not the ambient noise indicates a normal state on the basis of the abnormality degree obtained from the ambient model 14a and the threshold. As illustrated in FIG. 8, the ambient normality determination unit 15 transmits, to the history storage unit 6, ambient history information 15a in which date and time information indicating the date and time when the ambient noise was collected, position information indicating the position where the fixed microphone 11 is provided, the abnormality degree of the ambient noise, and the ambient determination result are associated with each other. Since the date and time information and the position information in the ambient history information 15a can be assigned by the history storage unit 6, the transmission to the history storage unit 6 may be omitted. In the second embodiment, since the abnormality degree is not used in the processing after the history storage unit 6, the transmission to the history storage unit 6 may be omitted.

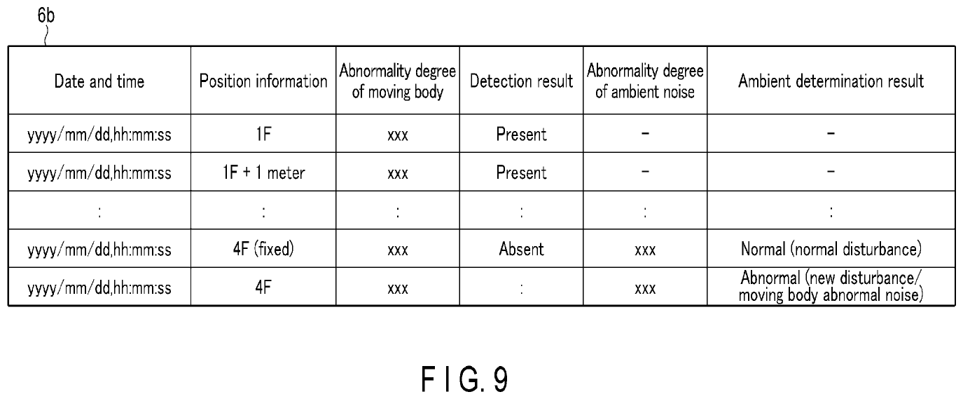

Accordingly, as illustrated in FIG. 9, the history storage unit 6 stores history information 6b in which history information based on the moving body microphone 2 and the ambient history information 15a based on the fixed microphone 11 are sequentially recorded.

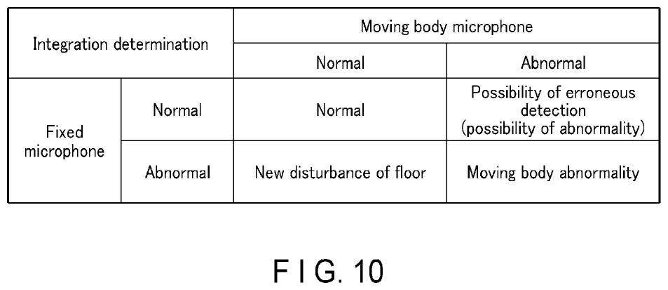

The integration unit 7 further integrates the determination results of the ambient normality determination unit 15 to determine the presence or absence of abnormality of the moving body. For example, in a case where more than a certain number of detection results are obtained at substantially the same position on the basis of the result of integrating the detection results for each piece of the position information, the integration unit 7 further integrates the determination results indicating that the ambient noise is abnormal, thereby determining that there is an abnormality of the car 1 of the moving body. In addition, for example, in a case where more than a certain number of detection results are obtained at substantially the same position on the basis of the result of integrating the detection results for each piece of the position information, the integration unit 7 further integrates the determination results indicating that the ambient noise is normal, thereby suspending determination of the presence of an abnormality of the car 1 and determining possibility of erroneous detection with respect to the detection results. As illustrated in FIG. 10, such a determination is obtained by integrating the detection result of the abnormal noise based on the moving body microphone 2 and the determination result of the normality or abnormality of the ambient noise based on the fixed microphone 11. In FIG. 10, the item “NORMAL” in the row of the moving body microphone corresponds to absence of the detection result of the abnormal noise. The item “ABNORMAL” in the row of the moving body microphone corresponds to the presence of the detection result of the abnormal noise. For example, in a case where the item “NORMAL” in the row of the fixed microphone is integrated with the item “ABNORMAL” in the column of the moving body microphone, the abnormality of the moving body suggests a possibility of erroneous detection due to mixing of normal ambient noise. In addition, in a case where the item “ABNORMAL” in the row of the fixed microphone is integrated with the item “ABNORMAL” in the column of the moving body microphone, since the abnormality of the ambient noise suggests the determination due to the mixing of the abnormal noise of the moving body, it can be determined that the abnormality of the moving body has occurred with higher accuracy. Note that, in a case where the item “ABNORMAL” in the row of the fixed microphone is integrated with the item “NORMAL” in the column of the moving body microphone, it can be determined that the new disturbance is mixed in the ambient noise but the noise is not collected by the moving body microphone 2. In this case, the accuracy of the ambient model 14a can be improved by adding the new disturbance to the learning data for the ambient model 14a.

Other configurations are the same as those of the first embodiment.

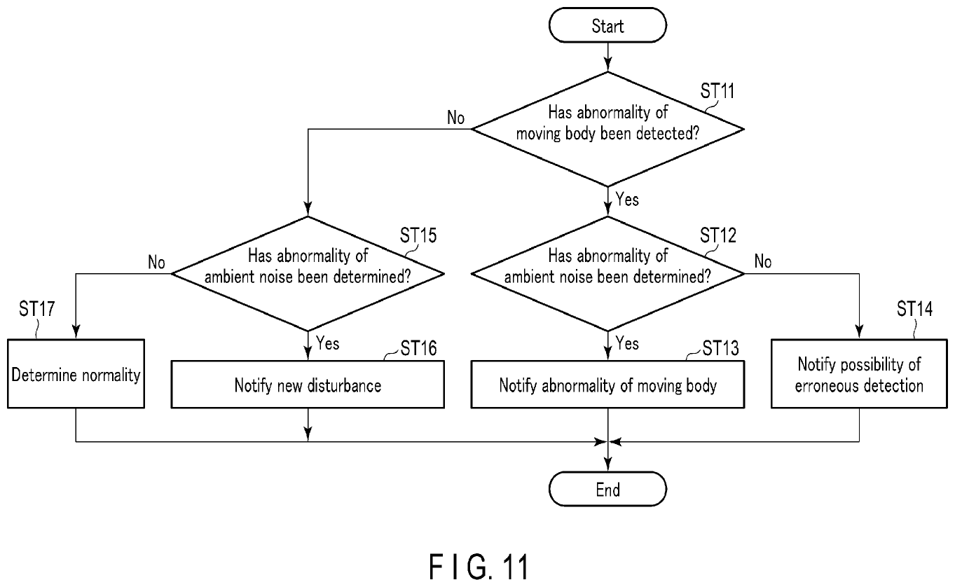

Next, the operation of the abnormal noise detection device configured as described above will be described with reference to the flowchart of FIG. 11. In the following description, it is assumed that the abnormal noise detection model 9a and the ambient model 14a are trained models in a state where machine learning has been completed.

First, the moving body microphone 2 collects the operating noise of the car. The abnormality detection unit 4 inputs the operating noise to the abnormal noise detection model 9a, and determines whether or not an abnormal noise has been detected in the operating noise on the basis of the abnormality degree obtained from the abnormal noise detection model 9a. In a case where an abnormal noise is detected (there is a detection result of the abnormal noise), the operating noise indicates an abnormal state, and in a case where no abnormal noise is detected (there is no detection result of the abnormal noise), the operating noise indicates a normal state. In addition, the abnormality detection unit 4 transmits information including date and time information, an abnormality degree of the moving body, and presence or absence of a detection result to the history storage unit 6.

On the other hand, fixed microphone 11 collects ambient noise at a position in the vicinity of the door on the 4F floor. The ambient normality determination unit 15 inputs the collected ambient noise to the ambient model 14a, and determines whether the ambient noise indicates a normal state on the basis of the abnormality degree obtained from the ambient model 14a. The ambient normality determination unit 15 transmits, to the history storage unit 6, ambient history information 15a in which date and time information indicating the date and time when the ambient noise was collected, position information indicating the position where the fixed microphone 11 is provided, the abnormality degree of the ambient noise, and the ambient determination result are associated with each other. The history storage unit 6 stores the information transmitted from the abnormality detection unit 4, the position information input from the position information input unit 5, and the ambient history information 15a in association with each other as the history information 6b.

As illustrated in FIGS. 10 and 11, the integration unit 7 further integrates the determination result of the ambient normality determination unit 15 with respect to the result of integrating the detection results for each piece of the position information on the basis of the history information to determine the presence or absence of abnormality of the car 1 as the moving body (steps ST11 to ST17). Note that steps ST11 to ST17 are an example of a procedure for performing the determination illustrated in FIG. 10, and can be modified as appropriate.

In step ST11, the integration unit 7 determines whether or not an abnormality of the moving body is detected on the basis of the detection result included in the history information, and if an abnormality of the moving body is detected (if there is a detection result), the process proceeds to step ST12. When a result of the determination in step ST11 is No, the process proceeds to step ST15.

In step ST12, the integration unit 7 determines whether an abnormality of the ambient noise has been detected on the basis of the ambient determination result included in the history information, and if an abnormality of the ambient noise has been detected, the process proceeds to step ST13. When a result of the determination in step ST12 is No, the process proceeds to step ST14.

In step ST13, the integration unit 7 determines the presence of an abnormality of the moving body on the basis of the abnormality of the operating noise of the car 1 corresponding to the column of the moving body microphone 2 and the abnormality of the ambient noise corresponding to the row of the fixed microphone 11 in FIG. 10, and transmits the determination result to the abnormality notification unit 8. The abnormality notification unit 8 notifies a remote monitoring device (not illustrated) of the abnormality of the moving body, and terminates the processing.

In step ST14, the integration unit 7 determines the possibility of erroneous detection for the abnormality of the operating noise on the basis of the abnormality of the operating noise of the car 1 corresponding to the column of the moving body microphone 2 and the normality of the ambient noise corresponding to the row of the fixed microphone 11 in FIG. 10, and transmits the determination result to the abnormality notification unit 8. In addition, the integration unit 7 suspends the determination of the presence of an abnormality of the car 1 as the moving body. The abnormality notification unit 8 notifies the remote monitoring device that there is a possibility of erroneous detection of the abnormality of the operating noise, and ends the processing.

In step ST15, the integration unit 7 determines whether an abnormality of the ambient noise has been detected on the basis of the ambient determination result included in the history information, and if an abnormality of the ambient noise has been detected, the process proceeds to step ST16. When a result of the determination in step ST15 is No, the process proceeds to step ST17.

In step ST16, the integration unit 7 determines that the cause of the abnormality of the ambient noise is the new disturbance of the floor on the basis of the normality of operating noise of the car 1 with respect to the column of the moving body microphone and the abnormality of the ambient noise with respect to the row of the fixed microphone in FIG. 10, and transmits the determination result to the abnormality notification unit 8. The abnormality notification unit 8 notifies the remote monitoring device that the abnormal cause of the ambient noise is a new disturbance of the floor, and ends the process.

In step ST17, the integration unit 7 determines normality of the moving body based on normality of the operating noise of the car 1 corresponding to the row of the moving body microphone 2 and normality of the ambient noise corresponding to the row of the fixed microphone 11 in FIG. 10, and ends the processing.

As described above, according to the second embodiment, the fixed microphone 11 is provided at a position in the vicinity of the door of the 4F floor in the peripheral area along the travel path of the car 1, and collects ambient noise at the provided position. The ambient normality determination unit 15 is provided for each fixed microphone 11, and determines whether the ambient noise indicates normality or abnormality. The integration unit 7 further integrates the determination results of the ambient normality determination unit 15 to determine the presence or absence of abnormality of the car 1 as the moving body. Therefore, by further integrating the determination result of the ambient noise in addition to the effects described above, the determination accuracy of the presence or absence of abnormality of the moving body can be further improved.

According to the second embodiment, in a case where more than a certain number of detection results are obtained at substantially the same position on the basis of the integrated results, the integration unit 7 further integrates the determination results indicating that the ambient noise is abnormal, thereby determining that there is an abnormality of the car 1 as the moving body. Therefore, by further integrating the determination result of the ambient noise in addition to the effects described above, the determination accuracy of the presence of abnormality of the moving body can be further improved.

In addition, according to the second embodiment, in a case where more than a certain number of detection results are obtained at substantially the same position on the basis of the integrated result, the determination results indicating that the ambient noise is normal is further integrated, thereby suspending determination of the presence of an abnormality of the moving body. which is the car 1, and determining possibility of erroneous detection with respect to the detection results. Therefore, in addition to the effects described above, by further integrating the determination result of the ambient noise, it is possible to determine that there is a possibility of erroneous detection in the detection result of the abnormal noise of the moving body.

Furthermore, according to the second embodiment, the ambient model storage unit 14 is provided for each fixed microphone 11, and stores the ambient model 14a, which is a trained model that generates the abnormality degree of the ambient noise on the basis of the collected ambient noise. The ambient normality determination unit 15 inputs the ambient noise to the ambient model 14a which is a trained model, and determines whether or not the ambient noise indicates a normal state on the basis of the abnormality degree obtained from the ambient model 14a. Therefore, in addition to the effects described above, the abnormality degree of the ambient noise can be obtained.

### Third Embodiment

In the second embodiment, the presence or absence of abnormality of the moving body is determined using the ambient noise from one fixed microphone 11.

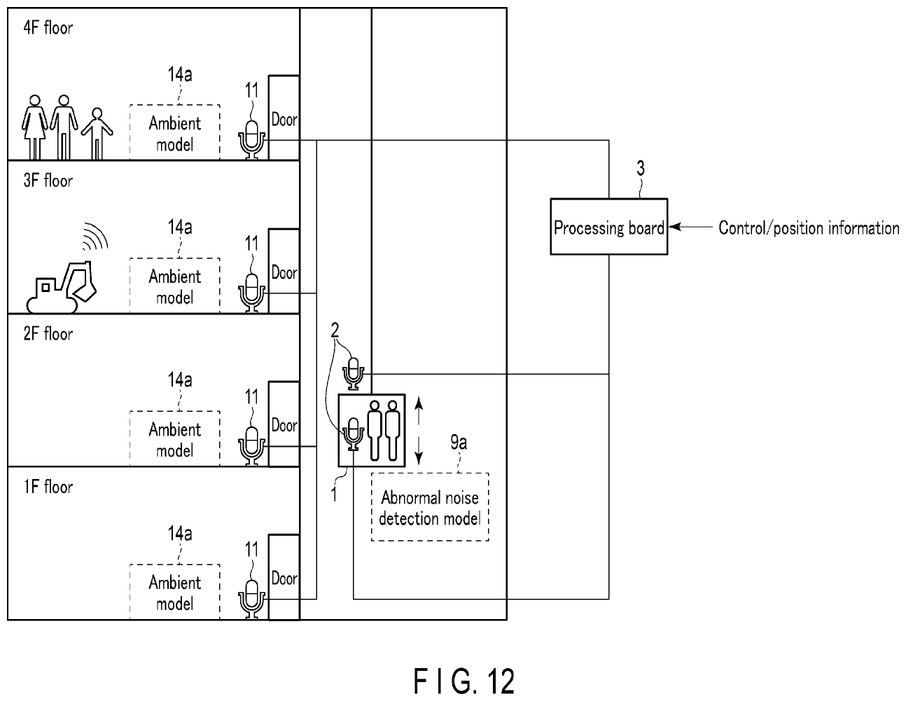

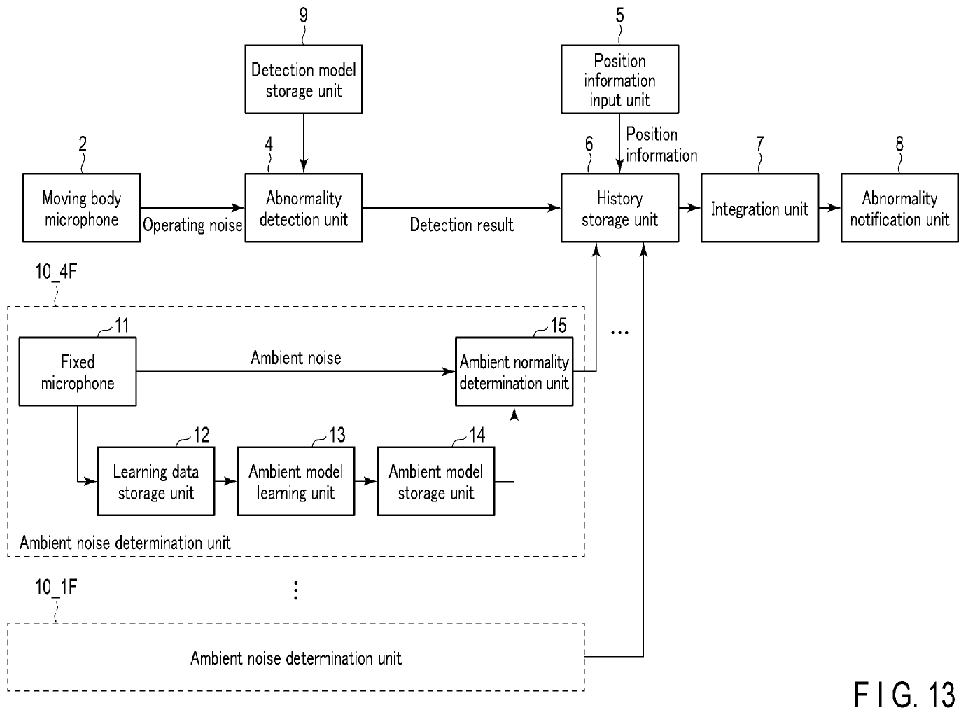

On the other hand, in the third embodiment, as illustrated in FIGS. 12 and 13, the presence or absence of the abnormality of the moving body is determined using the ambient noises from the fixed microphones 11 at the two positions closest to the position information of the detection result of the abnormal noise. For example, in the elevator device, the fixed microphone 11 is installed for each floor, and when an abnormal noise is detected while the car 1 is moving up and down between the second floor and the third floor, the presence or absence of an abnormality of the moving body is determined using the ambient noises from the two fixed microphones 11 on the second floor and the third floor closest to the position information corresponding to the detection result. In the example illustrated in FIGS. 12 and 13, four fixed microphones 11 are used, but the number of the plurality of fixed microphones 11 is not limited to four.

FIG. 13 is a block diagram illustrating an example of a configuration of the abnormal noise detection device according to the third embodiment. The abnormal noise detection device includes a plurality of fixed microphones 11, a learning data storage unit 12, an ambient model learning unit 13, an ambient model storage unit 14, and an ambient normality determination unit 15 illustrated in FIG. 7. Here, the fixed microphone 11, the learning data storage unit 12, the ambient model learning unit 13, the ambient model storage unit 14, and the ambient normality determination unit 15 are provided in each of the plurality of ambient noise determination units 10_1F to 10_4F. Note that the last two digits of the reference numeral of each of the ambient noise determination units 10_1F to 10_4F represents each of the 1F to 4F floors provided with the fixed microphone 11.

Along with this, in addition to the functions described above, the integration unit 7 further integrates the determination result of the ambient noise at the position closest to the position of the detection result of the abnormal noise on the basis of the position information. Accordingly, the integration unit 7 determines the presence or absence of abnormality of the moving body.

Other configurations are the same as those of the second embodiment.

According to the above-described configuration, the operation and effect of the second embodiment can be obtained for each floor provided with the fixed microphone 11. In addition, in a case where the car 1 which is a moving body is located between two floors, the integration unit 7 further integrates the determination results of the ambient noises at two positions closest to the position of the detection result of the abnormal noise on the basis of the position information, and determines the presence or absence of abnormality of the moving body. Therefore, in addition to the effects described above, the ambient noise between the two floors can be determined to be abnormal without providing a fixed microphone between the two floors. Therefore, it is possible to efficiently reduce erroneous detection as compared with a case where a fixed microphone is provided also between two floors.

### Fourth Embodiment

In the third embodiment, the presence or absence of the abnormality of the moving body is determined using the ambient noises from the fixed microphones 11 at two positions having the closest position information from the plurality of fixed microphones 11.

On the other hand, in the fourth embodiment, it is determined whether or not to update the ambient model 14a on the basis of the determination result of the ambient noise. In addition, in the fourth embodiment, the information regarding the abnormal noise and the information regarding the abnormality of the ambient noise are displayed on the display unit.

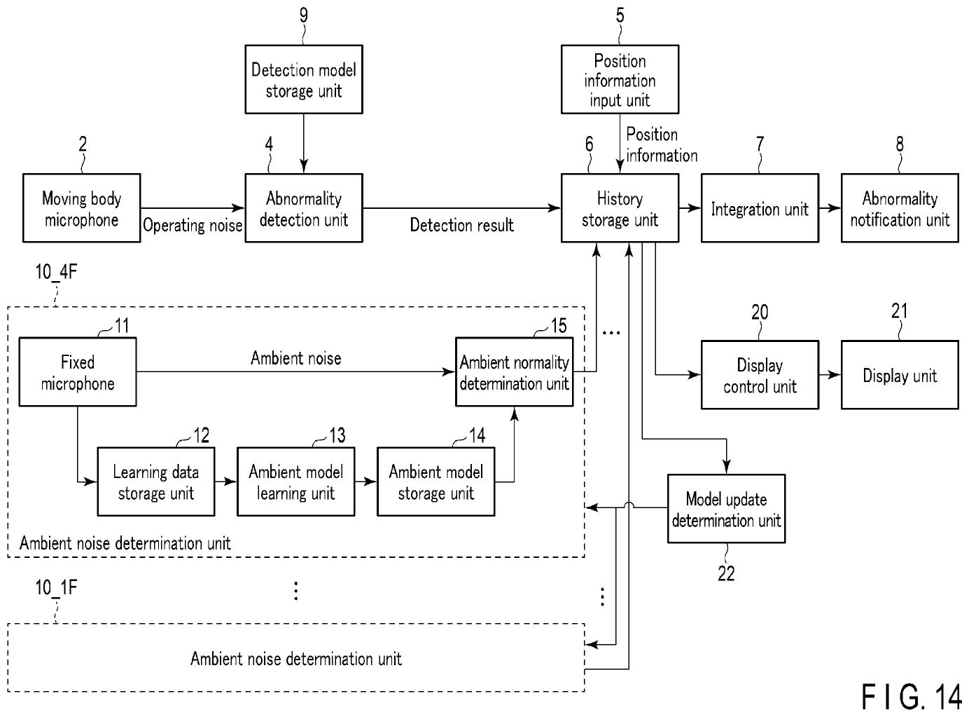

FIG. 14 is a block diagram illustrating an example of a configuration of the abnormal noise detection device according to the fourth embodiment. The abnormal noise detection device further includes a display control unit 20, a display unit 21, and a model update determination unit 22 as compared with the configuration illustrated in FIG. 13.

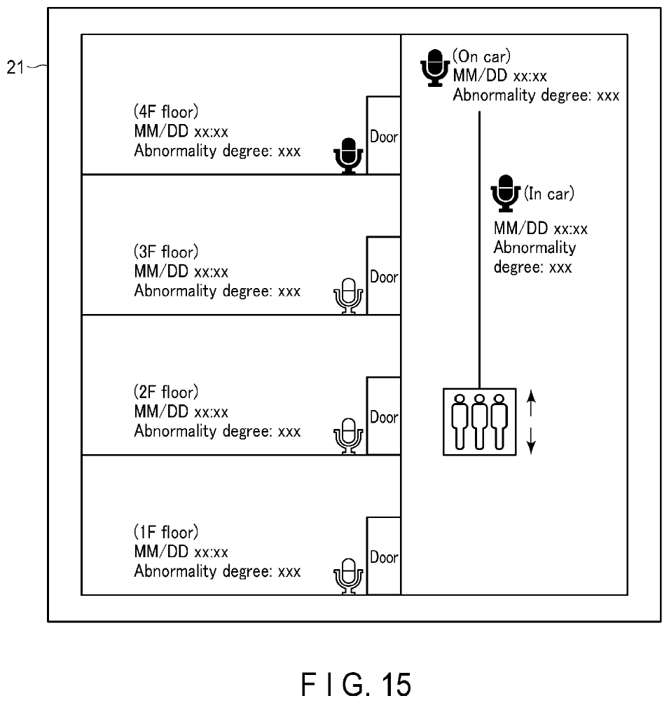

Here, the display control unit 20 causes the display unit 21 to display information included in the history information on the basis of the history information in the history storage unit 6. For example, as illustrated in FIG. 15, the display control unit 20 may cause the display unit 21 to display the information regarding the abnormal noise and the information regarding the abnormality of the ambient noise on the basis of the history information. In FIG. 15, the information regarding the abnormal noise is the display of the date and time when the abnormal noise was detected, the abnormality degree, and the presence of the detection result (red microphone display), and is displayed at the detection position on the travel path of the car 1. In addition, the information regarding the abnormality of the ambient noise includes date and time information, an abnormality degree, and a display of normality determination (green microphone display) or a display of abnormality determination (red microphone display), and is displayed for each floor. As a supplement, in a case where there is the detection result of the abnormal noise and there is the abnormality determination of the ambient noise, as illustrated in FIG. 15, the red display of the fixed microphone 11 is arranged at a position in the vicinity of the red display of the moving body microphone 2. That is, the history of the fixed microphone 11 at the same date and time corresponding to the position and history of one abnormality detection based on the moving body microphone 2 is displayed. In this case, since the determination result of the ambient noise of the fixed microphone 11 can be grasped at a glance, it can be expected that the user such as a maintenance engineer can easily determine whether the detection result of the abnormal noise of the moving body is erroneous detection or a true abnormality. Further, the display control unit 20 may display the information related to the abnormal noise on the right side while the car 1 is moving, and may display the information related to the abnormal noise on the left side when the car 1 is stopped such as when the door is opening or closing. That is, the display control unit 20 may change the display position of the information regarding the abnormal noise according to the operation state of the car 1.

The display unit 21 is a display controlled by the display control unit 20, and can display arbitrary information. The display unit 21 may be realized as, for example, a display of a tablet terminal carried by a maintenance engineer, or may be realized as a display provided in the car 1. Note that the display control unit 20 and the display unit 21 may be applied to the first or second embodiment.

The model update determination unit 22 determines whether or not to update the ambient model 14a that is the trained model on the basis of the ambient determination result in the history information. For example, when the determination result of the ambient model 14a of a certain floor is frequently abnormal, the model update determination unit 22 can determine that the disturbance of the floor has changed from that at the time of learning, and it is difficult to make a determination regarding the floor by the trained model. Note that the state that has changed from that at the time of learning corresponds to, for example, a state in which the type of disturbance has changed among various types of disturbances, a state in which there is a severe temporal change in the disturbance, and the like. In this case, it can be expected that updating the ambient model 14a of the floor further improves the accuracy. In addition, the ambient model 14a may be updated when a certain time has elapsed, when a new disturbance of the floor is detected, or the like. Note that, as a method of updating the ambient model 14a, for example, additional learning and relearning can be appropriately used. Furthermore, the model update determination unit 22 may be applied to the second embodiment.

Other configurations are the same as those of the third embodiment.

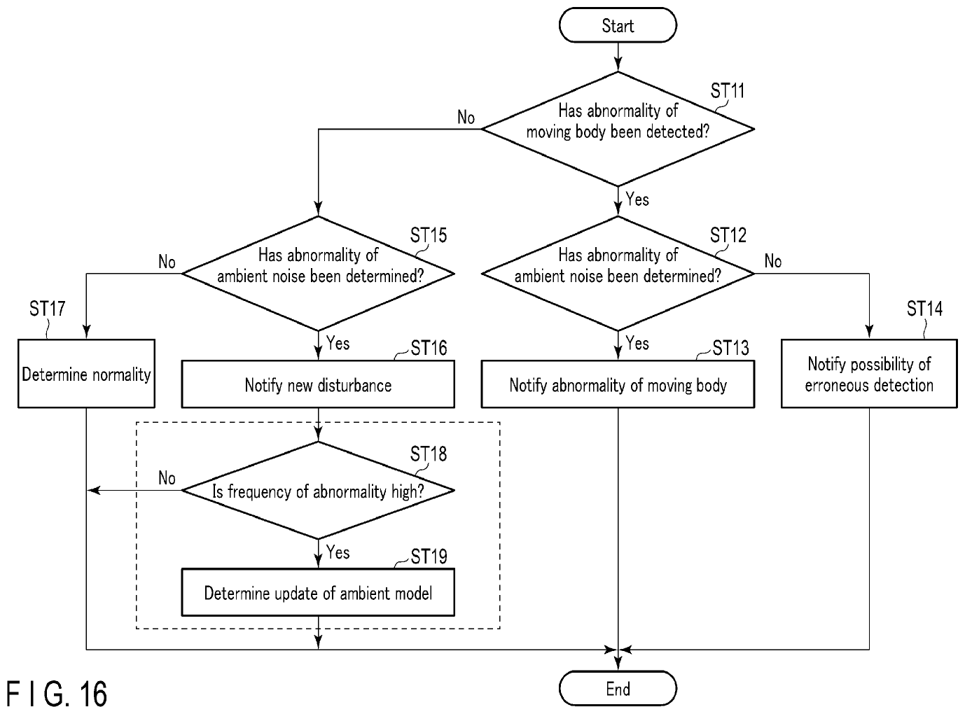

Next, the operation of the abnormal noise detection device configured as described above will be described with reference to the flowchart of FIG. 16. In FIG. 16, steps ST11 to ST17 are executed in the same manner as those described above. At this time, as illustrated in FIG. 15, the display control unit 20 causes the display unit 21 to display the information included in the history information on the basis of the history information in the history storage unit 6. As a result, the user such as a maintenance engineer can visually grasp the information regarding the abnormal noise and the information regarding the abnormality of the ambient noise for each position of the elevator device.

On the other hand, after step ST16, in step ST18, the model update determination unit 22 determines whether or not the frequency at which the ambient determination result in the history information indicates an abnormality is high. As a result of this determination, if the frequency of indicating abnormality is high, the process proceeds to step ST19, and if not, the process ends.

In step 19, the model update determination unit 22 determines to update the ambient model 14a, and transmits the determination result to the abnormality notification unit 8. The abnormality notification unit 8 notifies the remote monitoring device of the determination result indicating that the ambient model 14a is to be updated, and terminates the process.

As described above, according to the fourth embodiment, the model update determination unit 22 determines whether or not to update the ambient model 14a on the basis of the determination result in the history information. Therefore, in addition to the effects described above, since it is possible to determine the update of the ambient model 14a when the ambient model 14a does not match the current state, it is possible to reduce erroneous detection caused by the ambient model 14a that does not match the current state.

Furthermore, according to the fourth embodiment, the display control unit 20 causes the display unit 21 to display the information regarding the abnormal noise and the information regarding the abnormality of the ambient noise on the basis of the history information. Therefore, in addition to the effects described above, the user such as a maintenance engineer can visually grasp the information on the abnormal noise and the information on the abnormality of the ambient noise from the display unit 21.

### Fifth Embodiment

The fifth embodiment is a modification of the first to fourth embodiments, and not only the presence or absence of the abnormality of the moving body is determined, but also the position information and the abnormality detection result are integrated and determined for the estimation of the abnormal site.

Specifically, in addition to the configuration of any one of the first to fourth embodiments, the integration unit 7 outputs information on the distribution of the detection results of the abnormal noise with respect to the position of the car 1 on the basis of the history information in a case where it is determined that there is an abnormality of the car 1 which is a moving body.

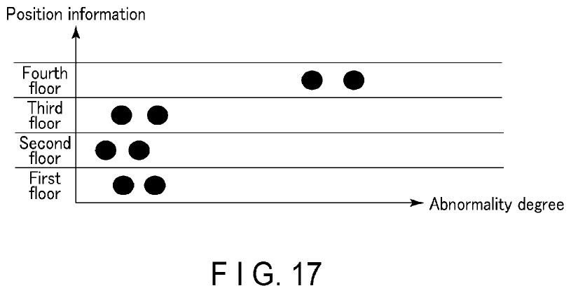

FIG. 17 is a scatter diagram for estimating an abnormal site according to a fifth embodiment. This scatter diagram is an example in which the abnormality degree of the detection result of the abnormal noise based on the moving body microphone 2 is displayed on the horizontal axis, and the position information when the abnormal noise is detected is displayed on the vertical axis. In FIG. 17, a high abnormality degree is displayed for a plurality of times on the 4th floor. As a result, the maintenance engineer can determine that an abnormality has occurred in the vicinity of the 4th floor, and can estimate, for example, a failure of the speed governor fixedly installed in the upper part of the 4th floor. In addition, in a case where a high abnormality degree frequently occurs from the second floor to the third floor, for example, it can be estimated that an abnormal noise is detected when balance weights pass each other.

As described above, according to the fifth embodiment, when determining that there is an abnormality of the moving body, the integration unit 7 outputs the information on the distribution of the detection results with respect to the position of the moving body on the basis of the history information. Therefore, in addition to the effects described above, the abnormal site of the moving body can be estimated on the basis of the distribution of the detection results of the abnormal noise.

In the fifth embodiment, the maintenance engineer who looks at the scatter diagram estimates the abnormal site, but the present invention is not limited thereto. For example, the abnormality candidate information in which the position information is associated with the abnormal position candidate may be held in the memory. In this case, the integration unit 7 can read out the candidates of the abnormal site from the abnormality candidate information in the memory on the basis of the position information indicating the high abnormality degree for a plurality of times and display the candidates on the display unit 21. As a result, in addition to the effects of the fifth embodiment, it is possible to present candidates for an abnormal site to an inexperienced maintenance engineer.

### Sixth Embodiment

The sixth embodiment is a specific example of the first to fifth embodiments, and is an aspect in which the abnormal noise detection device described above is realized by a computer.

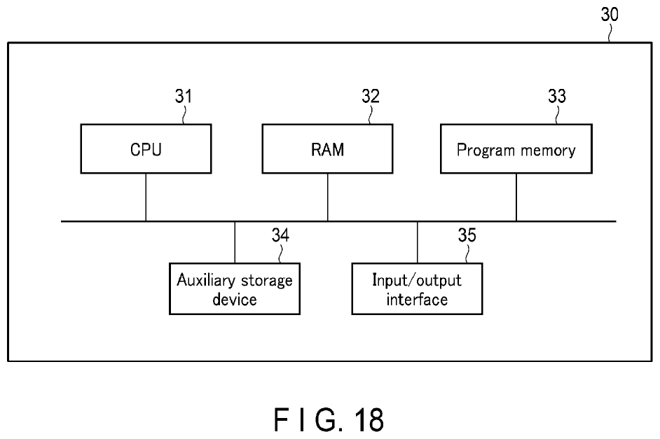

FIG. 18 is a block diagram illustrating a hardware configuration of the abnormal noise detection device according to the sixth embodiment. The abnormal noise detection device 30 includes, as hardware, a central processing unit (CPU) 31, a random access memory (RAM) 32, a program memory 33, an auxiliary storage device 34, and an input/output interface 35. The CPU 31 communicates with the RAM 32, the program memory 33, the auxiliary storage device 34, and the input/output interface 35 via a bus. The hardware configuration can be mounted on the processing board 3 illustrated in FIGS. 1, 6, and 12 and each of the ambient noise determination units 10_1F to 10_4F illustrated in FIGS. 13 and 14.

The CPU 31 is an example of a general-purpose processor. The CPU 31 is an example of a first processing circuit and a second processing circuit. For example, the CPU 31 is mounted on the processing board 3 as a first processing circuit. Furthermore, for example, the CPU 31 is provided as a second processing circuit in each of the ambient noise determination units 10_1F to 10_4F.

The RAM 32 is used as a working memory for the CPU 31. The RAM 32 includes a volatile memory such as a synchronous dynamic random access memory (SDRAM). The program memory 33 stores a program for realizing each component according to each embodiment. This program may be, for example, a program for causing a computer to realize each function of the abnormal noise detection device described above. Furthermore, as the program memory 33, for example, a read-only memory (ROM), a part of the auxiliary storage device 34, or a combination thereof is used. The auxiliary storage device 34 non-transitorily stores data. The auxiliary storage device 34 includes a nonvolatile memory such as a hard disc drive (HDD) or a solid state drive (SSD).

The input/output interface 35 is an interface for connecting to another device. The input/output interface 35 is used, for example, for connection with the moving body microphone 2, the fixed microphone 11, a keyboard, a mouse, and the display unit 21.

The programs stored in the program memory 33 include computer-executable instructions. When executed by the CPU 31 which is a processing circuit, the program (computer-executable instruction) causes the CPU 31 to execute predetermined processing. For example, when the program is executed by the CPU 31, the program causes the CPU 31 to execute a series of processes described for each component of FIGS. 2, 7, 13, and 14. For example, the computer executable instruction included in the program, when executed by the CPU 31, causes the CPU 31 to execute the abnormal noise detection method. The abnormal noise detection method may include steps corresponding to the functions of the abnormal noise detection device described above. For example, the abnormal noise detection method may include: collecting an operating noise of a moving body by a microphone installed in the moving body; detecting an abnormal noise in the operating noise; inputting position information of the moving body; storing history information in which a detection result of detecting the abnormal noise and the position information are associated with each other in a memory; and determining presence or absence of abnormality of the moving body by integrating the detection result for each piece of the position information on the basis of the history information. Furthermore, the abnormal noise detection method may appropriately include the steps illustrated in FIGS. 5, 11, and 16.

The program may be provided to the abnormal noise detection device 30 in a state of being stored in a computer-readable storage medium. In this case, for example, the abnormal noise detection device 30 further includes a drive (not illustrated) that reads data from a storage medium, and acquires a program from the storage medium. As the storage medium, for example, a magnetic disk, an optical disk (CD-ROM, CD-R, DVD-ROM, DVD-R, and the like), a magneto-optical disk (MO or the like), a semiconductor memory, or the like can be appropriately used. The storage medium may be referred to as a non-transitory computer readable storage medium. Alternatively, the program may be stored in a server on the communication network, and the abnormal noise detection device 30 may download the program from the server using the input/output interface 35.

The processing circuit that executes the program is not limited to a general-purpose hardware processor such as the CPU 31, and a dedicated hardware processor such as an application specific integrated circuit (ASIC) may be used. The term “processing circuit” (processing unit) includes at least one general purpose hardware processor, at least one special purpose hardware processor, or a combination of at least one general purpose hardware processor and at least one special purpose hardware processor. In the example illustrated in FIG. 18, the CPU 31, the RAM 32, and the program memory 33 correspond to a processing circuit.

### Modification of Each Embodiment

Note that the abnormal noise detection device according to each embodiment and each modification can be provided not only in the elevator but also in any moving body such as a train, a bus, or an automatic guided vehicle. In addition, each embodiment and each modification may be expressed as a moving body device (for example an elevator device) including an abnormal noise detection device. Similarly, each embodiment and each modification may be expressed as an abnormal noise detection method or a program including each step of the above-described abnormal noise detection device.

According to at least one embodiment described above, it is possible to reduce erroneous detection of an abnormal noise due to an ambient noise other than a moving body to be monitored. The same applies to at least one modification described above.

While certain embodiments have been described, these embodiments have been presented by way of example only, and are not intended to limit the scope of the inventions. Indeed, the novel embodiments described herein may be embodied in a variety of other forms;

furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An abnormal noise detection device comprising a first processing circuit configured to:
collect an operating noise of a moving body by a first microphone installed in the moving body;
detect an abnormal noise in the operating noise;
input position information of the moving body;
store history information in which a detection result of detecting the abnormal noise and the position information are associated with each other in a first memory; and
determine presence or absence of abnormality of the moving body by integrating the detection result for each piece of the position information on a basis of the history information.

2. The abnormal noise detection device according to claim 1, wherein the first processing circuit determines the presence of the abnormality of the moving body when more than a certain number of the detection results are obtained at substantially the same position on a basis of the integrated result.

3. The abnormal noise detection device according to claim 1, further comprising a second processing circuit provided at at least one position in a peripheral region along a travel path of the moving body, wherein
the second processing circuit is configured to:
collect ambient noise of the provided position by a second microphone; and
determine whether the ambient noise indicates normality or abnormality for each second microphone, and
the first processing circuit is further configured to:
further store a determination result related to the ambient noise as the history information in the first memory; and
determine presence or absence of the abnormality of the moving body by further integrating determination results regarding the ambient noise on a basis of the history information.

4. The abnormal noise detection device according to claim 3, wherein the first processing circuit is further configured to determine the presence of the abnormality of the moving body by further integrating the determination results indicating that the ambient noise is abnormal when more than a certain number of the detection results are obtained at substantially the same position on a basis of the integrated result.

5. The abnormal noise detection device according to claim 3, wherein the first processing circuit is further configured to suspend determination of the presence of the abnormality of the moving body by further integrating the determination results indicating that the ambient noise is normal when more than a certain number of the detection results are obtained at substantially the same position on a basis of the integrated result, and determines possibility of erroneous detection with respect to the detection results.

6. The abnormal noise detection device according to claim 3, further comprising a second memory that is provided for each second microphone and stores a trained model that generates an abnormality degree of the ambient noise on a basis of the collected ambient noise, wherein the second processing circuit is further configured to input the ambient noise to the trained model, and determines whether or not the ambient noise indicates a normal state on a basis of the abnormality degree obtained from the trained model.

7. The abnormal noise detection device according to claim 3 further comprising a plurality of the second processing circuits, wherein the first processing circuit is further configured to further integrate the determination results of two positions closest to the position of the detection result on a basis of the position information.

8. The abnormal noise detection device according to claim 6, wherein the first processing circuit is further configured to determine whether or not to update the trained model on a basis of the determination result in the history information.

9. The abnormal noise detection device according to claim 3, wherein the first processing circuit is further configured to cause a display to display the information on the abnormal noise and the information on the abnormality of the ambient noise on a basis of the history information.

10. The abnormal noise detection device according to claim 1, wherein the first processing circuit is further configured to output information regarding a distribution of the detection result with respect to the position of the moving body on a basis of the history information in a case where it is determined that there is an abnormality of the moving body.

11. An elevator device comprising the abnormal noise detection device according to claim 1.

12. An abnormal noise detection method comprising:
collecting an operating noise of a moving body by a microphone installed in the moving body;
detecting an abnormal noise in the operating noise;
inputting position information of the moving body;
storing history information in which a detection result of detecting the abnormal noise and the position information are associated with each other in a memory; and
determining presence or absence of abnormality of the moving body by integrating the detection result for each piece of the position information on a basis of the history information.

13. A non-transitory computer readable storage medium including computer executable instructions, wherein the instructions, when executed by a processor, cause the processor to perform a method comprising:
collecting an operating noise of a moving body by a microphone installed in the moving body;
detecting an abnormal noise in the operating noise;
inputting position information of the moving body;
storing history information in which a detection result of detecting the abnormal noise and the position information are associated with each other in a memory; and
determining presence or absence of abnormality of the moving body by integrating the detection result for each piece of the position information on a basis of the history information.
